(19) United States
(12) Patent Application Publication
(10) Pub. No.: US 2003/0056627 A1
(43) Pub. Date: Mar. 27, 2003

(54) Post-harvest vegetable processing process and device

(75) Inventor: Truffaux Hubert, Boves (FR)

Correspondence Address: NIXON & VANDERHYE P.C., 8th Floor, 1100 North Glebe Road, Arlington, VA, 22201-4714, US

(73) Assignee: ABC Metal

(21) Appl. No.: 10/286,803

(22) Filed: Nov. 4, 2002

Related U.S. Application Data
(63) Continuation of application No. 09/659,004, filed on Sep. 11, 2000, now abandoned.

(30) Foreign Application Priority Data
Sep. 10, 1999 (FR) 99 11715

(51) Int. Cl. B26D 1/00; B26D 3/00

(52) U.S. Cl. 83/13; 83/932

(57) ABSTRACT

The present invention relates to a post-harvest vegetable processing process and device.

The process is characterised in that it comprises:

a step consisting of supplying and conveying the vegetables in a line, such that each vegetable is oriented in a specified direction,

a step consisting of detecting and analysing each vegetable,

a step consisting of processing each vegetable according to the analysis of the vegetable, said processing step consisting of at least one cutting or removal operation of at least one specified portion of the vegetable using at least one tool comprising two jaws.

### FIELD OF THE INVENTION

The present invention relates to a post-harvest vegetable processing process and device. The process and device according to the invention particularly enable cutting and/or removal of portions of vegetables, citrus fruit, fruit and tubers. The device according to the invention may be used on a mobile harvesting machine for this produce or in a fixed station workshop.

### BACKGROUND OF THE INVENTION

The problem involved in harvesting and processing vegetables, fruit and tubers is that automation is difficult without damaging the vegetables due to their fragile nature. In this way, broccoli, cauliflower and cabbage, for example, are processed manually by operators in order to package them after the harvest on a processing site.

### OBJECTS AND SUMMARY OF THE INVENTION

Therefore, the aim of the present invention is to compensate for the disadvantages of the prior art by firstly proposing an automated post-harvest vegetable processing process, which does not damage the vegetables.

This aim is achieved by the fact that the post-harvest specified vegetable processing process is characterised in that it comprises:

a step consisting of supplying and conveying the vegetables in a line, such that each vegetable is oriented in a specified direction,

a step consisting of detecting and analysing each vegetable,

a step consisting of processing each vegetable according to the analysis of the vegetable, said processing step consisting of at least one cutting or removal operation of at least one specified portion of the vegetable using at least one tool comprising two jaws.

According to another embodiment, the detection and analysis step comprises detection of the size and/or colour and/or shape and/or position of each vegetable.

According to another embodiment, the detection and analysis step comprises analysis between the information representing the detection and memorised reference vegetable models.

According to another embodiment, the processing step consists of neutralising the cutting or removal operation(s) of at least one portion of the produce to keep the vegetable intact.

According to another embodiment, the vegetable processing process is characterised in that it comprises:

a step consisting of sorting portions of vegetables or whole vegetables, in order to package them and/or recycle them for the manufacture of food by-products.

Another aim of the invention is to propose an automated post-harvest vegetable processing device which does not damage vegetables.

This aim is achieved by the fact that the post-harvest specified vegetable processing device is characterised in that it comprises, firstly, supply means on conveying means designed to orient the vegetables in a specified direction, in a line, and, secondly, detection means positioned on the vegetable conveying path and connected to control means which receive the information representing the detection performed by the detection means, said control means controlling the movement and actuation of the mobile cutting and/or removal means positioned downstream from the detection means according to the processing of the information received, the mobile cutting and/or removal means comprising at least one sharp tool comprising two mobile jaws.

According to another embodiment, the control means control and determine the speed at which the vegetables move via a control link connected to the conveying means, to calculate the position in which the cutting and/or removal means should operate.

According to another embodiment, the detection means comprise an optical and/or mechanical and/or electronic system used to determine the size and/or colour and/or shape and/or position of each vegetable.

According to another embodiment, the control means comprise a computerised processing system determining, on the basis of a comparison between the information representing the detection and the reference vegetable models and/or the mechanical processing to be performed, the area(s) of the vegetable to be cut or removed.

According to another embodiment, the jaws of the cutting and/or removal means are actuated by a cylinder controlled by the control means.

According to another embodiment, the mobile cutting and/or removal means are mounted on a frame which moves in translation along the vertical axis.

According to another embodiment, the device comprises means for conveying and storing each of the vegetable portions for their packaging or use in the manufacture of by-products.

According to another embodiment, the device comprises vegetable portion sorting means controlled by the control means.

According to another embodiment, the vegetables include vegetables, fruit or tubers such as artichokes, asparagus, beetroot, broccoli, carrots, celery, mushrooms, cabbage, cucumber, lettuce, lambs' lettuce, melon, turnips, nectarines, oranges, watermelon, peaches, pears, grapefruit, apples, potatoes, romanesco, salad vegetables, tomatoes.

According to another embodiment, each sharp tool is mobile between two positions, a first position in which the cutting tool is able to cut at least one vegetable portion and a second position in which the cutting tool evacuates the vegetable portion it has cut.

According to another embodiment, a plurality of tools is mounted on a support such that each tool moves between the first and second position.

### BRIEF DESCRIPTION OF DRAWINGS

The present invention's other embodiments and advantages will be seen more clearly upon reading the description below referring to the figures appended, wherein:

FIG. 1 represents a top view of the device according to the invention,

FIG. 2 represents a front view of the cutting station of the device according to the invention,

FIG. 3 represents a side view of the cutting station of the device according to the invention,

FIGS. 4A and 4B represent a front and side view, respectively, of an example of an embodiment of a cutting and/or removal tool in the open position.

FIGS. 5A and 5B represent a front and side view, respectively, of an example of an embodiment of a cutting and/or removal tool closing.

### DESCRIPTION OF THE PREFERRED EMBODIMENTS

As explained above, the device according to the invention is designed to process vegetables after they are harvested. The specified vegetables liable to be processed by the device according to the invention are, for example, vegetables, fruit or tubers such as artichokes, asparagus, beetroot, broccoli, carrots, celery, mushrooms, cabbage, cucumber, lettuce, lambs' lettuce, melon, turnips, nectarines, oranges, watermelon, peaches, pears, grapefruit, apples, potatoes, romanesco, salad vegetables, tomatoes.

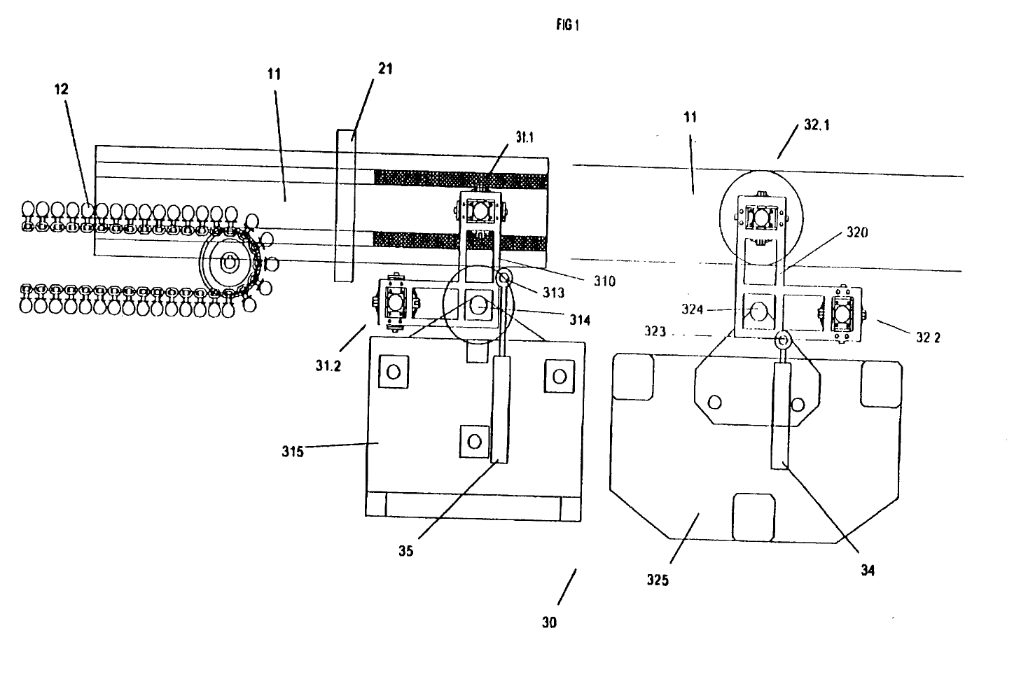

The processing device according to the invention will now be described with reference to FIGS. 1 to 3. The device comprises supply and conveying means 11, 12, a processing station comprising detection means 21 positioned on the vegetable conveying path and mobile means 30 to cut and/or remove at least one portion of each vegetable. Said cutting and/or removal means 30 are controlled by control means (not shown) which receive information transmitted by the detection means 21, representing the detection carried out, on an input. The cutting and/or removal means 30 are actuated as a function of the processing of the information received, performed by the control means. The detection carried out by the detection means 21 may consist of determining the size and/or colour and/or shape and/or position of each vegetable conveyed. The processing performed by the control means consists of comparing the size and/or colour and/or shape and/or position of each vegetable with the size and/or colour and/or shape and/or position of at least one reference vegetable model, previously stored in memory, and thus determining which portion(s) of the conveyed vegetable should be cut or removed.

The supply and conveying means 11, 12 are designed to feed vegetables roughly in a line and oriented in a specified direction. This characteristic makes it possible to obtain an approximately identical cutting or removal axis for all the vegetables and therefore limit the movement of the cutting and removal means 30, which, firstly, reduces the cutting cycle time and, secondly, decreases the manufacturing cost of the cutting and/or removal means 30.

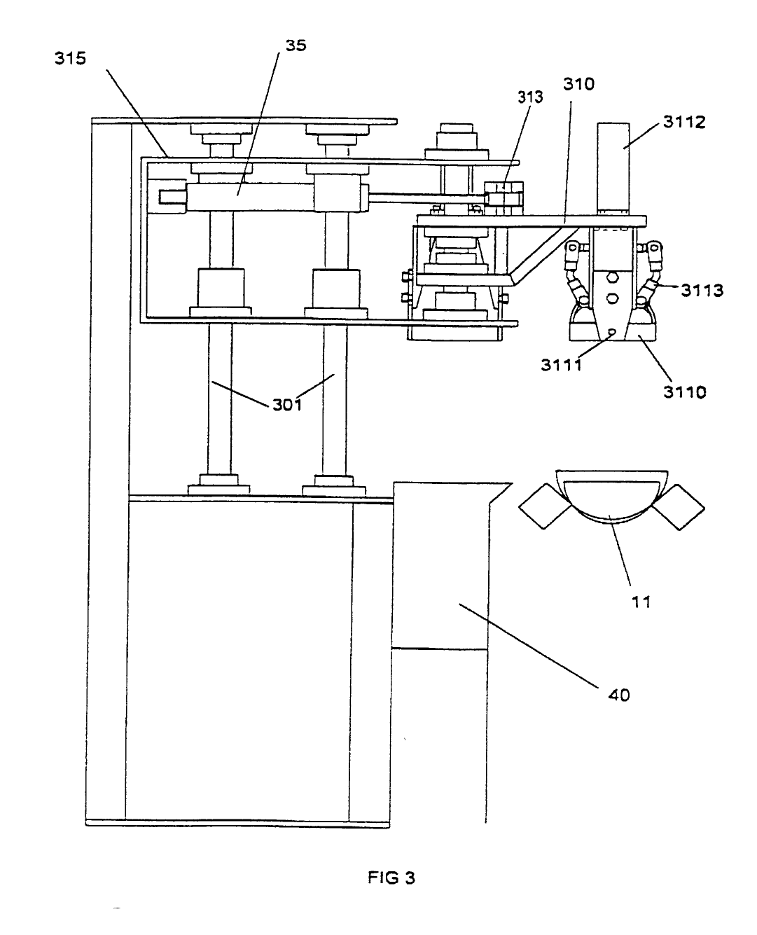

The device represented in FIGS. 1 to 3 is designed to process vegetables such as broccoli. In this embodiment, the supply and conveying means 11, 12 comprise, for example, a first horizontal conveyor belt 11. The vegetables are conveyed roughly in a line on the first conveyor 11, by a second conveyor 12 designed to orient the vegetables in the required direction. When the vegetables, such as broccoli, are oval-shaped, to ensure that they retain the required orientation when transferred to the first conveyor 11, said conveyor can form a chute, as shown in the section view in FIG. 3. For vegetables such as broccoli, the preferred orientation is when the stem is approximately vertical and pointing upwards. In this way, the vegetables always have approximately the same profile when they enter the processing station. Similarly, the vegetables almost always present the same portion to the cutting and/or removal means 30.

The detection means 21 comprise, for example, optical, mechanical or electronic type sensors. In one embodiment, the detection means 21 comprise a camera connected to an image processing device. In this way, in the case of broccoli, the detection means are used to determine the height and/or size and/or colour of the broccoli conveyed. This information is then transmitted to control means (not shown). Said control means comprise, for example, a computerised processing system which compares, using a suitable program, the information produced and transmitted by the detection means representing, for example, the height and/or size and/or colour of the broccoli conveyed with information representing one or more broccoli models. In this way, for example, according to the size or height of a piece of broccoli, the computerised system determines which portion(s) or which stem height should be cut to retrieve an optimal amount of processed broccoli flowerets. The computerised system can also determine whether a piece of broccoli should not be processed, for example, because its shape and/or height and/or colour correspond to those of a predefined broccoli model or they meet special previously defined criteria stored in memory in the computerised system. In this case, the mobile cutting and/or removal means 30 are not actuated when the piece of broccoli selected by the computerised system moves under the cutting means 30. The computerised system may also comprise a man-machine interface enabling an operator to enter, for example, specific selection settings for the vegetables to be processed and, for example, a specific type of processing.

Similarly, the control means may also control the supply and conveying means 11, 12, for example, via a control link. In particular, the control means may modify the movement speed of the horizontal conveyor 11 to adapt said speed to the processing speed of the cutting and/or removal means 30. In addition, the control link enables the control means to know the exact movement speed of the vegetables on the horizontal conveyor 11 and therefore know the exact time to cover the distance between the detection means and the cutting and/or removal means 30 and therefore determine the position of each vegetable with a calculation. In this case, said calculation makes it possible to activate the processing of a vegetable with a delay after detection. Said delay corresponds approximately to the time to cover the distance between the detection means and the cutting and/or removal means 30. Finally, the control of the conveying means 11 also makes it possible to anticipate the processing of the vegetables and therefore optimise the processing cycle time and obtain continuous supply and conveying of the vegetables.

The cutting and/or removal means 30 comprise at least one sharp cutting and/or removal tool 31.1, 31.2, 32.1, 32.2. Each tool 31.1, 31.2, 32.1, 32.2 is mounted on a mobile support 310, 320 in the processing station area, such that the position of each tool 31.1, 31.2, 32.1, 32.2 can be modified at least in terms of height, according to the portion(s) of the vegetable to be cut or removed. Each cutting and/or removal tool 31.1, 31.2, 32.1, 32.2 may also be mobile between two positions, a first position in which the cutting and/or removal tool 31.1, 31.2, 32.1, 32.2 is able to cut at least one vegetable portion and a second position in which the sharp tool evacuates the vegetable portion that it has cut.

According to the embodiment represented in FIGS. 1 to 3, the cutting and/or removal means 30 comprise, for example, two pairs of removal tools 31.1, 31.2, 32.1, 32.2.

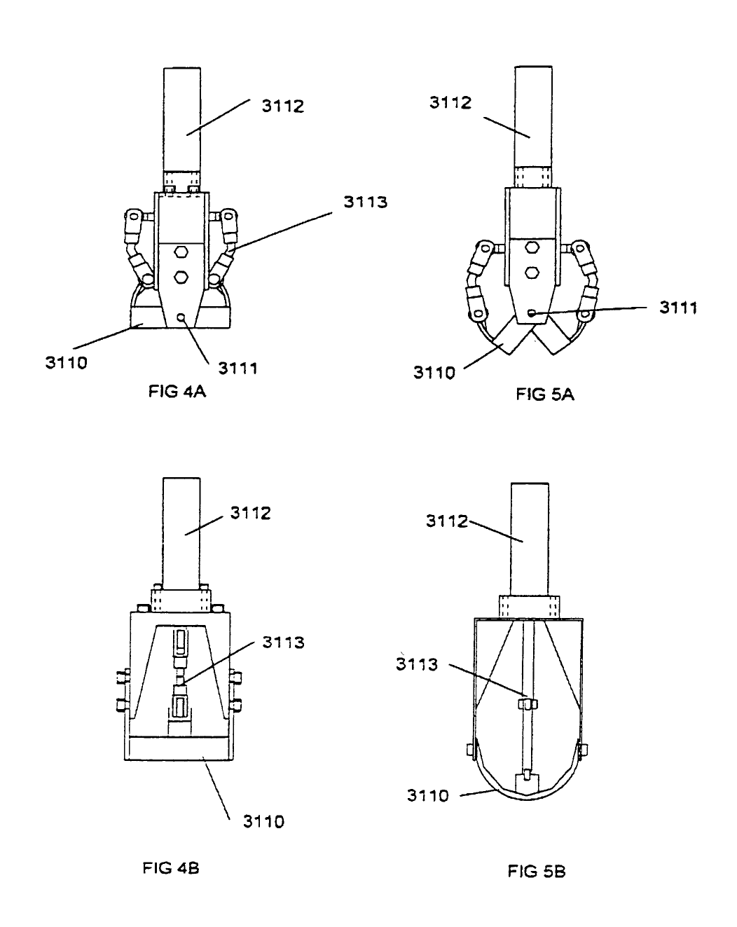

FIGS. 4A, 4B, 5A, 5B represent detailed views of an example of an embodiment of a cutting and/or removal tool adapted to process broccoli. Each tool 31.1, 31.2, 32.1, 32.2 comprises two jaws 3110 mounted on a fixed pivoting axis 3111 and attached to a toggle joint system 3113. The toggle joint system 3113 moves in vertical translation, via a cylinder 3112 controlled by the control means. The use of the cylinder 3112 causes either the tool to close by pivoting the jaws 3110 on their axis 3111 with, at the end of travel, a shearing effect obtain by overlapping of the jaws 3110 on each other, which results in the cutting or removal of a portion of the vegetable, or the jaws 3110 to open.

In FIGS. 1 to 3, to be able to cut or remove a vegetable portion at different heights, the support 310, 320 of each pair of tools 31.1, 31.2, 32.1, 32.2 is mounted on a frame 315, 325 sliding vertically on a plurality of guiding columns 301, for example, by means of a cylinder (not shown). Therefore, the implementation is controlled by the control means. In this way, the control means actuate said cylinder to adapt the height of the cutting and/or removal tools 31.1, 31.2, 32.1, 32.2 at the height determined according to the analysis by the computerised processing system of the information representing the detection.

In another variant (not shown), each tool 31.1, 31.2, 32.1, 32.2 may move in vertical translation individually.

In the variant represented in FIGS. 1 to 3, each support 310, 320 is comprised in a horizontal plane and is roughly L-shaped and the tools 31.1, 31.2, 32.1, 32.2 of each support 310, 320 are mounted at the free end of each arm of the L. Each support 310, 320 is also mounted pivoting on the frame 315, 325, the pivoting axis 311, 312 merging with the join of the arms of the L forming the support 310, 320. The pivoting movement is obtained by means of a second cylinder 34, 35 attached to the frame 315, 325 and mounted on one arm of the L forming the support 310, 320, shifted in relation to the pivoting axis 314, 324. The second cylinder 34, 35 is mounted on the support 310, 320, for example, by a pivot type link 313, 323 to enable the movement of the second cylinder 34, 35 in relation to the support 310, 320. The use of the second cylinder 34, 35 results in the pivoting of the support 310, 320 along a 90° angle. Said pivoting enables the tools 31.1, 31.2, 32.1, 32.2 of a support 310, 320 to work in alternation.

Indeed, when one of the tools 31.1, 31.2, 32.1, 32.2 of a support 310, 320 is in the processing position, i.e. it is ready or in the process of cutting or removing a portion of a vegetable, the other tool 31.1, 31.2, 32.1, 32.2 of the same support 310, 320 ejects the cut or removed portion, into a recycling hopper 40, for example. In this way, part of the processing of the vegetable is conducted in masked time, which reduces the vegetable processing cycle time considerably.

After processing, the vegetables may be conveyed, for example, by the horizontal conveyor 11, or by successive conveyors, to a sorting station (not shown). Said station comprises, for example, selection means, such as handling fingers, and storage means. Sorting may be controlled by the computerised system of the control means. Indeed, the computerised system receives information representing the height and/or size and/or colour of each vegetable to be processed. In this way, according to the processing carried out, the computerised system determines the category in which the processed vegetable is to be stored. Once this category has been determined, the selection means are then actuated by the control means, to convey the processed vegetable to the storage means corresponding to the category determined by the control means.

In another embodiment, the sorting station is autonomous, i.e. it comprises its own means to detect and process the information representing the detection, to determine the category of a processed vegetable and then actuate selection means, to convey the processed vegetable to storage means corresponding to the category determined by the detection and processing means.

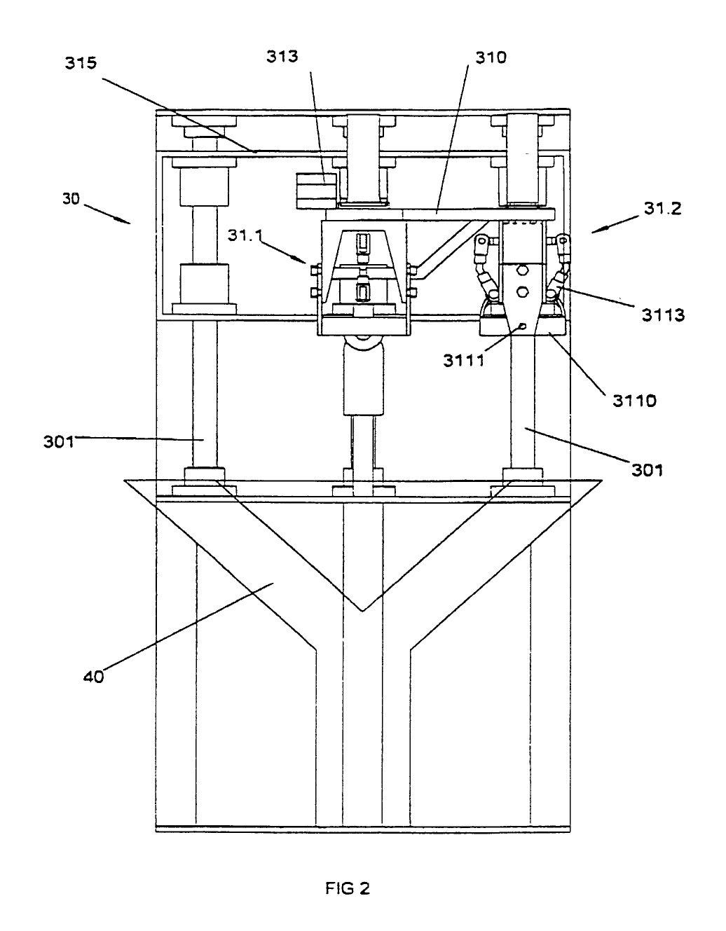

After sorting, the processed vegetables may be packaged or used in the manufacture of products or by-products. Similarly, the vegetable portions resulting from cutting and placed in the recycling hopper 40, FIG. 2 and 3 may also be stored in storage means for subsequent packaging or use in the manufacture of products and by-products.

The present disclosure corresponds to an application to the processing of broccoli, particularly the separation of broccoli flowerets. However, the device described above may be adapted to process other vegetables. For this, it is simply necessary to modify the supply and conveying means 11, 12 to orient the vegetable in the required direction and the cutting and/or removal tools to obtain the required processing. Similarly, it is necessary to modify or set the program for analysing and processing the information representing the detection so as to adapt the use of the cutting and/or removal tools according to the vegetable and required processing.

It is clear that other modifications that may be made by specialists come within the scope of the invention.

1. Post-harvest specified vegetable processing process characterised in that it comprises:
a step consisting of supplying and conveying the vegetables in a line, such that each vegetable is oriented in a specified direction,
a step consisting of detecting and analysing each vegetable,
a step consisting of processing each vegetable according to the analysis of the vegetable, said processing step consisting of at least one cutting or removal operation of at least one specified portion of the vegetable using at least one tool comprising two jaws.

2. Post-harvest vegetable processing process according to claim 1, characterised in that the detection and analysis step comprises detection of the size and/or colour and/or shape and/or position of each vegetable.

3. Post-harvest vegetable processing process according to claim 1 or 2, characterised in that the detection and analysis step comprises analysis between the information representing the detection and memorised reference vegetable models.

4. Post-harvest vegetable processing process according to claim 1, characterised in that the processing step consists of neutralising the cutting or removal operation(s) of at least one portion of the produce to keep the vegetable intact.

5. Post-harvest vegetable processing process according to claim 1, characterised in that it comprises:
a step consisting of sorting portions of vegetables or whole vegetables, in order to package them and/or recycle them for the manufacture of food by-products.

6. Post-harvest specified vegetable processing process, characterised in that it comprises, firstly, supply means (12) on conveying means (11) designed to orient the vegetables in a specified direction, in a line, and, secondly, detection means (21) positioned on the vegetable conveying path and connected to control means which receive the information representing the detection performed by the detection means (21), said control means controlling the movement and actuation of the mobile cutting and/or removal means (30) positioned downstream from the detection means (21) according to the processing of the information received, the mobile cutting and/or removal means (30) comprising at least one sharp tool (31.1, 31.2, 32.1, 32.2) comprising two mobile jaws.

7. Post-harvest vegetable processing device according to claim 6, characterised in that the control means control and determine the speed at which the vegetables move via a control link connected to the conveying means (11), to calculate the position in which the cutting and/or removal means (31.1, 31.2, 32.1, 32.2) should operate.

8. Post-harvest vegetable processing device according to claim 6 or 7, characterised in that the detection means (21) comprise an optical and/or mechanical and/or electronic system used to determine the size and/or colour and/or shape and/or position of each vegetable.

9. Post-harvest vegetable processing device according to any of claims 6 to 8, characterised in that the control means comprise a computerised processing system determining, on the basis of a comparison between the information representing the detection and the reference vegetable models and/or the mechanical processing to be performed, the area(s) of the vegetable to be cut or removed.

10. Post-harvest vegetable processing device according to any of claims 6 to 9, characterised in that the jaws (3110) of the cutting and/or removal means (30) are actuated by a cylinder (3112) controlled by the control means.

11. Post-harvest vegetable processing device according to any of claims 6 to 10, characterised in that the mobile cutting and/or removal means (30) are mounted on a frame (315, 325) which moves in translation along the vertical axis.

12. Post-harvest vegetable processing device according to any of claims 6 to 10, characterised in that it comprises means (11) for conveying and storing each of the vegetable portions for their packaging or use in the manufacture of by-products.

13. Post-harvest vegetable processing device according to any of claims 6 to 10, characterised in that it comprises vegetable portion sorting means controlled by the control means.

14. Post-harvest vegetable processing device according to any of claims 6 to 10, characterised in that the vegetables include vegetables, fruit or tubers such as artichokes, asparagus, beetroot, broccoli, carrots, celery, mushrooms, cabbage, cucumber, lettuce, lambs' lettuce, melon, turnips, nectarines, oranges, watermelon, peaches, pears, grapefruit, apples, potatoes, romanesco, salad vegetables, tomatoes.

15. Post-harvest vegetable processing device according to any of claims 10 to 11, characterised in that each sharp tool (31.1, 31.2, 32.1, 32.2) is mobile between two positions, a first position in which the cutting tool is able to cut at least one vegetable portion and a second position in which the cutting tool evacuates the vegetable portion it has cut.

16. Post-harvest vegetable processing device according to any of claims 10 to 11, characterised in that a plurality of tools (31.1, 31.2, 32.1, 32.2) is mounted on a support (310, 320) such that each tool (31.1, 31.2, 32.1, 32.2) moves between the first and second position.
